(19) United States
(12) Patent Application Publication
(10) Pub. No.: US 2008/0117130 A1
(43) Pub. Date: May 22, 2008

(54) METHOD OF DRIVING PLASMA DISPLAY PANEL

(76) Inventors: Seong-joon Jeong, Suwon-si (KR); Woo-joon Chung, Suwon-si (KR); Seung-won Choi, Suwon-si (KR)

Correspondence Address: CHRISTIE, PARKER & HALE, LLP, PO BOX 7068, PASADENA, CA, 91109-7068, US

(21) Appl. No.: 11/940,246

(22) Filed: Nov. 14, 2007

(30) Foreign Application Priority Data
Nov. 21, 2006 (KR) 10-2006-0115155

(51) Int. Cl. G09G 3/28

(52) U.S. Cl. 345/60

(57) ABSTRACT

A method for driving a plasma display panel including pixels formed by a plurality of first electrodes, a plurality of second electrodes, and a plurality of third electrodes, the third electrodes crossing the first and second electrodes, the method including the steps of preparing a plurality of driving signal sets having different voltage waveforms to be applied to the first, second, and third electrodes; and applying one of the plurality of the driving signal sets to the first, second, and third electrodes in accordance with a temperature and a time.

### CROSS-REFERENCE TO RELATED APPLICATIONS

This application claims priority to and the benefit of Korean Patent Application No. 10-2006-0115155, filed on Nov. 21, 2006, in the Korean Intellectual Property Office, the entire content of which is incorporated herein by reference.

### BACKGROUND

1. Field of the Invention

The present invention relates to a method for driving a plasma display panel.

2. Discussion of Related Art

A plasma display panel (PDP) is a flat panel display that displays letters or an image by using plasma generated during the gas discharge process to cause phosphors to emit light. The plasma display panel has higher luminance and luminescence efficiency and a wider viewing angle than other flat panel displays, such as a liquid crystal display (LCD), a field emission display (FED), etc., and therefore the plasma display panel has come into the spotlight as a display device capable of replacing a cathode ray tube (CRT) display device.

The plasma display panel can be categorized as a DC-type plasma display panel or an AC-type plasma display panel, depending on a structure in which its pixels are arranged in a matrix, and voltage waveforms of its driving signals. In the case of the DC-type plasma display panel, charges are directly translocated (transported) between opposing electrodes since all the electrodes are exposed to the discharge gaps (i.e., not insulated). By contrast, in the AC-type plasma display panel, charges are not directly translocated between opposing electrodes because at least one of the opposing electrodes is surrounded by a dielectric material.

Also, a discharge structure of the plasma display panel can be categorized as an opposed discharge structure or a surface discharge structure, depending on configuration of the electrodes for discharging electricity. In the case of the opposed discharge structure, an address discharge for selecting pixels and a sustain discharge for sustaining a discharge are generated between a scan electrode (an anode) and an address electrode (cathode). By contrast, in the case of the surface discharge structure, an address discharge for selecting pixels is generated between an address electrode and a scan electrode crossing the address electrode, and a sustain discharge for sustaining a discharge is generated between the scan electrode and a sustain electrode.

The plasma display panel having the above-mentioned structure displays multiple gray level images using a method in which a unit frame is divided into a plurality of subfields and the subfields are driven in a time-divided manner. Each of the subfields is driven at a reset period for adjusting charges of pixels to a uniform state; at an address period for accumulating wall charges on the pixels to be driven; and at a sustain discharge period for sustaining a discharge used for displaying an image. For this driving method, a voltage waveform (or predetermined voltage waveform) of a driving signal is applied to each of the electrodes.

A conventional plasma display panel is usually set to be suitable for a certain temperature region, for example a relatively high temperature region, which may cause the conventional plasma display panel to consume a large amount of power and/or cause a deteriorated contrast when the temperature of the plasma display panel is in a room temperature region having a relatively low temperature. That is, the temperature in a plasma display panel is increased as its operating time increases, and therefore wall charges are accumulated in a relatively high capacity because the wall charges are more actively moving in discharge gaps if the temperature is relatively high. Therefore, a driving signal having a higher voltage is required for controlling wall charges when the temperature is relatively high, but an excessive power is consumed when the temperature of the plasma display panel is in the room temperature region or in a relatively low temperature region because it is being driven by the diving signal set with the relatively high voltage that is suitable for the high temperature region, and the contrast is deteriorated due to the increased quantity of light caused by the excessive discharges.

### SUMMARY OF THE INVENTION

An aspect of an embodiment of the present invention is directed to a method for driving a plasma display panel capable of maintaining optimal discharge conditions in accordance with changes of discharge characteristics based on temperature and time.

Another aspect of an embodiment of the present invention is directed to a method for driving a plasma display panel capable of maintaining optimal discharge conditions in accordance with changes of discharge characteristics based on temperature and use time.

An embodiment of the present invention provides a method for driving a plasma display panel including pixels formed by a plurality of first electrodes, a plurality of second electrodes, and a plurality of third electrodes, the third electrodes crossing the first and second electrodes, the method including the steps of preparing a plurality of driving signal sets having different voltage waveforms to be applied to the first, second, and third electrodes; and applying one of the plurality of the driving signal sets to the first, second, and third electrodes in accordance with a temperature and a time.

Another embodiment of the present invention provides a method for driving a plasma display panel including pixels formed by a plurality of first electrodes, a plurality of second electrodes, and a plurality of third electrodes, the third electrodes crossing the first and second electrodes, the method including the steps of preparing a plurality of driving signal sets having different voltage waveforms to be applied to the first, second, and third electrodes; measuring a temperature of the plasma display panel; measuring an operating time of the plasma display panel; and applying one of the plurality of the driving signal sets to the first, second, and third electrodes in accordance with the temperature of the plasma display panel and the operating time of the plasma display panel.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective schematic view illustrating a plasma display panel according to an embodiment of the present invention.

FIG. 2 is a schematic view showing a unit frame for displaying multiple gray levels of the plasma display panel of FIG. 1.

FIG. 3 is a waveform view showing a driving signal for driving the plasma display panel of FIG. 1 according to an embodiment of the present invention.

FIG. 4 is a graph showing a change of a firing voltage, depending on temperature.

FIG. 5 is a graph showing a method for driving a plasma display panel according to a first embodiment of the present invention.

FIG. 6 and FIG. 7 are graphs showing changes of a firing voltage at a room temperature and at a high temperature, depending on the use time.

FIG. 8 is a graph showing a method for driving a plasma display panel according to a second embodiment of the present invention.

FIG. 9 is a block view illustrating a plasma display apparatus according to an embodiment of the present invention.

### DESCRIPTION OF MAJOR PARTS IN THE FIGURES

| | |
|---|---|
| 110: first substrate | 111, 121: dielectric |
| 112: passivation layer | 120: second substrate |
| 122: barrier rib | 130: phosphor layer |
| 140: discharge gap | 200: pixel |
| 210: plasma display panel | 220: scan driver |
| 230: address driver | 240: sustain driver |

### DETAILED DESCRIPTION

Hereinafter, exemplary embodiments according to the present invention will be described with reference to the accompanying drawings. Here, when one element is described as being connected to another element, one element may be not only directly connected to another element but instead may be indirectly connected to another element via one or more other elements. Also, in the context of the present application, when an element is referred to as being “on” another element, it can be directly on the another element or be indirectly on the another element with one or more intervening elements interposed therebetween. Further, some of the elements that are not essential to the complete description of the invention have been omitted for clarity. Also, like reference numerals refer to like elements throughout.

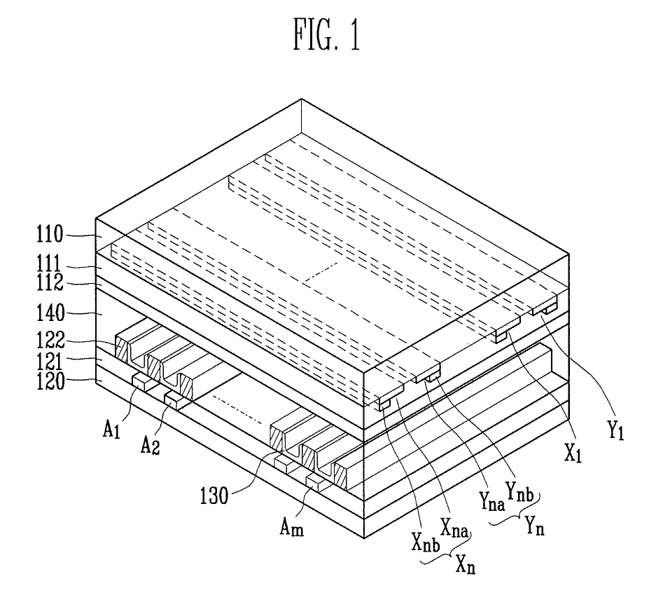

FIG. 1 is a perspective schematic view illustrating a plasma display panel according to an embodiment of the present invention. Here, the plasma display panel is shown to be driven in a 3-electrode surface emitting manner, but the present invention is not thereby limited.

Referring to FIG. 1, a large number of sustain electrode lines (X₁, . . . , Xₙ) and scan electrode lines (Y₁, . . . , Yₙ), which are covered with a dielectric 111 and a passivation layer 112, are formed in parallel on a first substrate 110. The sustain electrode lines (X₁, . . . , Xₙ) and the scan electrode lines (Y₁, . . . , Yₙ) are composed of transparent electrodes (Xₙₐ, Yₙₐ) formed of indium tin oxide (ITO), etc.; and metal electrodes (X_{nb}, Y_{nb}) for enhancing conductivity. A large number of address electrode lines (A₁, . . . , Aₘ) covered with a dielectric 121 are formed on a second substrate 120. A barrier rib 122 is formed in parallel with the address electrode lines (A₁, . . . , Aₘ) on the dielectric 121 between a large number of the address electrode lines (A₁, . . . , Aₘ), and phosphor layers 130 formed on both sides of the barrier rib 122 and on the dielectric 121. The first substrate 110 is adhered to the second substrate 120 so that the scan electrode lines (Y₁, . . . , Yₙ) and the address electrode lines (A₁, . . . , Aₘ), and the sustain electrode lines (X₁, . . . , Xₙ) and the address electrode lines (A₁, . . . , Aₘ) can cross (e.g., can cross at right angles), and a large number of pixels are formed by sealing a gas for forming a plasma in a closed discharge gap 140 formed by the barrier rib 122. The gas for forming a plasma includes inactive mixed gas selected from the group consisting of He+Xe, Ne+Xe, He+Xe+Ne, etc.

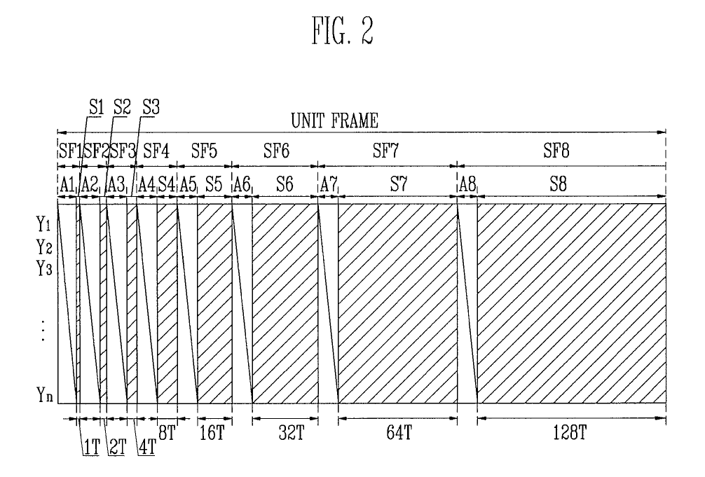

The plasma display panel, as configured above, displays a desired image by time-dividing a unit frame into a plurality of subfields (e.g., SF1, SF2, SF3, SF4, SF5, SF6, SF7, and SF8), as shown in FIG. 2, and by being sequentially driven during a reset period (PR), an address period (PA) and a sustain discharge period (PS) in each of subfields (e.g., from SF1 to SF8) by using a plurality of driving signals having different voltage waveforms, as shown in FIG. 3.

Referring to FIG. 3, all the wall charges of the pixels in which the sustain discharges are carried out in the previous subfield are erased and adjusted to a uniform state during the reset period (PR) so that the pixels can be easily (or more easily) selected in the next period. Here, the reset period (PR) is composed of a set up period to which a ramp up pulse is applied, and a set down period to which a ramp down pulse is applied.

For example, the ramp up pulse is applied to all the scan electrode lines (Y₁, . . . , Yₙ) during the set up period. The ramp up pulse is increased at a constant gradient from the sustain voltage (Vs) to the set up voltage (Vset). Positive (+) wall charges are accumulated on the address electrodes (A₁, . . . , Aₘ) and the sustain electrodes (X₁, . . . , Xₙ) and negative (+) wall charges are accumulated on the scan electrodes (Y₁, . . . , Yₙ) during a period when a dark discharge, in which the light is not substantially generated in all the pixels, is carried out by the ramp up pulse.

A ramp down pulse is applied to all the scan electrode lines (Y₁, . . . , Yₙ) during the set down period. The ramp down pulse starts to decrease from a positive voltage which is lower than the set up voltage (Vset), for example a sustain voltage (Vs), and then decreases to a ground voltage (V_{G}) or a certain negative voltage, for example a negative scan voltage (Vscn-l). Some of the wall charges, excessively formed by the ramp down pulse during the set up period, are erased to adjust wall charges of all the pixels to a uniform state, to thereby stably carry out an address discharge.

The address period (PA) is a period to accumulate a wall charge on pixels to be driven. During the address period (PA), a scan voltage (Vscn-l) is sequentially applied to the scan electrode lines (Y₁, . . . , Yₙ), and a data voltage (V_{A}) is simultaneously applied to the address electrode lines (A₁, . . . , Aₘ). At this time, electric potentials of all the scan electrode lines (Y₁, . . . , Yₙ) are sequentially changed from a positive (+) scan voltage (Vscn-h) to a negative (−) scan voltage (Vscn-l).

An address discharge is generated in the pixels to which the data voltage (V_{A}) is applied if a voltage having a difference between the scan voltage (Vscn-l) and the data voltage (V_{A}) is added to the wall voltage (or predetermined wall voltage) while the wall voltage (or predetermined wall voltage) is sustained during the reset period (PR). Therefore, a suitable wall charge to carry out a sustain discharge is formed in the selected pixels. At this time, an undesired discharge is prevented (or blocked) by applying the sustain voltage (V_{S}) to the sustain electrodes (X₁, . . . , Xₙ) to reduce a voltage difference between the scan electrodes (Y₁, . . . , Yₙ) and the sustain electrodes (X₁, . . . , Xₙ).

The sustain discharge period (PS) is to display an image by using the discharge in the selected pixel, and a pulse of a sustain voltage (V_{S}) having an opposing phase is applied to the scan electrode lines (Y₁, . . . , Yₙ) and the sustain electrode lines (X₁, . . . , Xₙ) of the selected pixels. If the sustain voltage (V_{S}) is added to the wall voltages of the selected pixels, then the selected pixels display an image by sustaining discharges between the scan electrodes (Y₁, . . . , Yₙ) and the sustain electrodes (X₁, . . . , Xₙ) in every sustain pulse cycle.

If the sustain discharge period (PS) is completed, then a voltage having a relatively narrow width and a relatively low level is applied to all the sustain electrode lines (X₁, . . . , Xₙ) to erase all the remaining wall charges from the pixels.

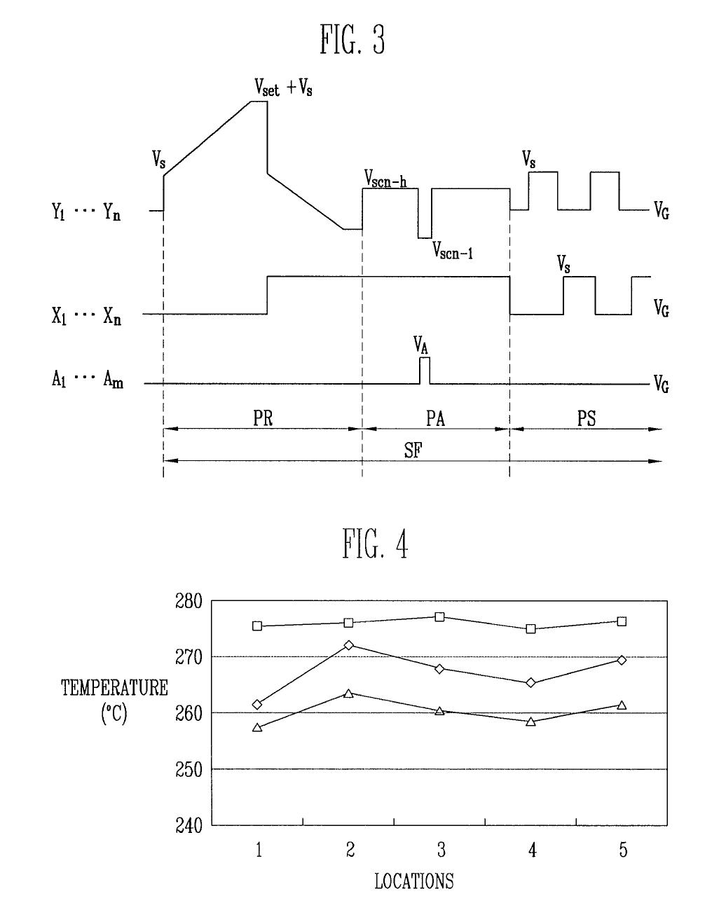

In the plasma display panel as configured above, its discharge characteristics are, however, changed depending on the temperature. FIG. 4 shows results obtained by measuring changes of firing voltages (Vf) in every location, depending on the temperature.

If the temperature of the plasma display panel increases, then space charges are more actively moved, and therefore the space charges are recombined with other space charges or wall charges at an increased level. If the wall charges are recombined with the space charges at an increased level, then the firing voltage (Vf) is increased with the decrease in the wall voltage. By contrast, if the temperature is lowered, then the wall charges are recombined with the space charges at a decreased level, and therefore the firing voltage is lowered with the increase in the wall voltage.

Accordingly, an embodiment of the present invention provides the method for driving a plasma display panel capable of maintaining optimal discharge conditions in accordance with changes of discharge characteristics based on the temperature by preparing a driving signal set, respectively, to be suitable for a low temperature region, a room temperature region and a high temperature region. Here, the driving signal set is applied to the scan electrodes (Y₁, . . . , Yₙ), the sustain electrodes (X₁, . . . , Xₙ) and the address electrodes (A₁, . . . , Aₘ), as shown in FIG. 3, and a plasma display panel is driven by using the selected driving signal sets, depending on the temperature regions.

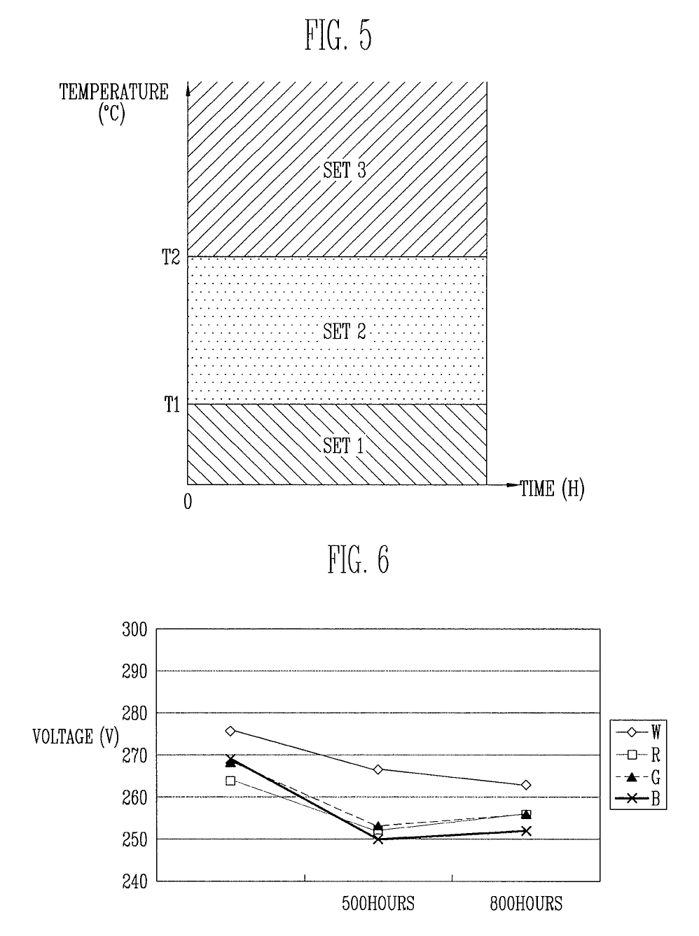

FIG. 5 is a graph showing a method for driving a plasma display panel according to a first embodiment of the present invention. As shown in FIG. 5, different waveforms of the first, second, and third driving signal sets (Set 1 to Set 3), which are applied to the scan electrodes (Y₁, . . . , Yₙ), the sustain electrodes (X₁, . . . , Xₙ) and the address electrodes (A₁, . . . , Aₘ), are prepared, and then one driving signal set of the first, second, and third driving signal sets (Set 1 to Set 3) is applied to the scan electrodes (Y₁, . . . , Yₙ), the sustain electrodes (X₁, . . . , Xₙ) and the address electrodes (A₁, . . . , Aₘ), depending on the temperature. At this time, the temperature is divided into a plurality of regions, for example a low temperature region, a room temperature region and a high temperature region, and one of the first, second, and third driving signal sets (Set 1 to Set 3) may be selected, based on critical temperatures (T1 and T2) between the temperature regions.

Referring to FIG. 5, assume that, for example, a region beneath a temperature (T1) is referred to as a low temperature region, a region from the temperature (T1) to a temperature (T2) is referred to as a room temperature region, and a region above the temperature (T2) is referred to as a high temperature region. Here, a first driving signal set (Set 1) used in the low temperature region; a second driving signal set (Set 2) used in the room temperature region; and a third driving signal set (Set 3) used in the high temperature region are prepared. At this time, the first, second, and third driving signal sets (Set 1 to Set 3), which may maintain the optimal discharge conditions in each of the temperature regions, are prepared in accordance with (or consideration of) the discharge characteristics in each of the temperature regions. The first, second, and third driving signal sets (Set 1 to Set 3) may be set by adjusting a voltage level or a voltage waveform (an amplitude or a cycle) of the driving signal, as shown in FIG. 3.

For example, a pulse width of the scan signal may be set to be relatively wide in the low temperature region and set to be relatively narrow in the high temperature region since the address discharge is delayed if the temperature is lowered, and a gradient (or a slope of a raise) of a ramp pulse is set to be relatively low in the low temperature region because the weak discharge characteristics are deteriorated by the ramp pulse if the temperature is relatively low.

The optimal discharge conditions may be maintained in the high temperature region by setting an edge of the ramp down pulse to a value which is different from a value in the low temperature region, by using one or more suitable methods that can suitably use effects of the temperatures on electric potential differences.

An independent sustain pulse may be applied in the high temperature region during the address period so as to compensate for a loss of the wall charges before the address period.

In addition, the discharge characteristics are changed depending on the temperature, and also changed depending on the use time in the plasma display panel. For example, if a firing voltage is measured at a constant temperature (60° C.), then a discharge is initiated at about 270 V at the beginning of an operation of the plasma display panel, but a discharge is initiated at a voltage lower (or substantially lower) than 270 V after hundreds of discharges.

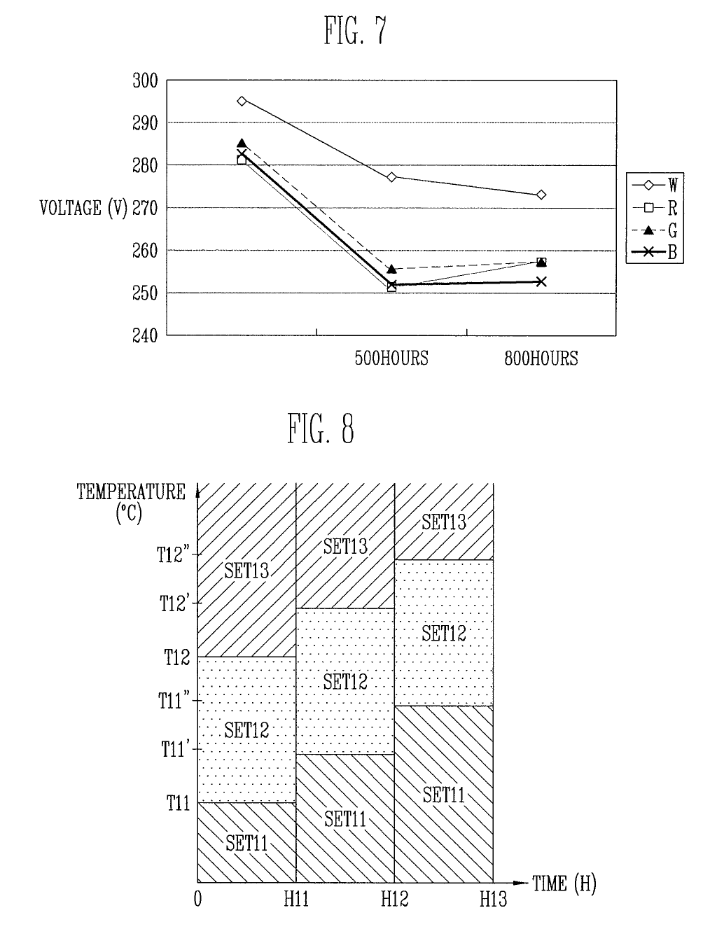

FIG. 6 and FIG. 7 are graphs showing changes of a firing voltage in a room temperature region and a high temperature region, depending on the use time. As shown in FIG. 6 and FIG. 7, the firing voltage is decreased as the use time increases. If the firing voltage is decreased as the use time increases, then a discharge margin is decreased, resulting in an undesired discharge (e.g., a low discharge). Accordingly, a second embodiment of the present invention provides a method for driving a plasma display panel capable of maintaining optimal discharge conditions in accordance with changes of discharge characteristics based on the temperature and the use time by preparing a driving signal set, respectively, to be suitable for a low temperature region, a room temperature region and a high temperature region and driving a plasma display panel by using the selected driving signal sets, depending on the temperature and the time, as described in the first embodiment.

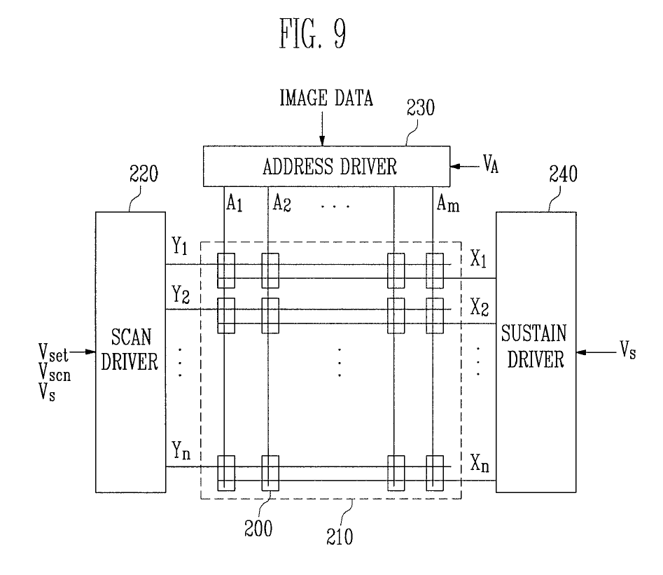

FIG. 8 is a graph showing a method for driving a plasma display panel according to the second embodiment of the present invention. As shown in FIG. 8, different waveforms of the first to the third driving signal sets (Set 11, Set 12, and Set 13), which are applied to the scan electrodes (Y₁, . . . , Yₙ), the sustain electrodes (X₁, . . . , Xₙ) and the address electrodes (A₁, . . . , Aₘ), are prepared, and then one driving signal set of the first, second, and third driving signal sets (Set 11, Set 12, and Set 13) is applied to the scan electrodes (Y₁, . . . , Yₙ), the sustain electrodes (X₁, . . . , Xₙ) and the address electrodes (A₁, . . . , Aₘ), depending on the temperature and the use time. At this time, the temperature and the use time are divided into a plurality of regions, respectively, and the ranges of the temperature regions or the critical temperatures between the temperature regions may be changed in the time regions, respectively.

For example, assume that a region beneath a temperature (T11) is referred to as a low temperature region, a region from the temperature (T11) to a temperature (T12) is referred to as a room temperature region, and a region above the temperature (T12) is referred to as a high temperature region. Here, a first driving signal set (Set 11) used in the low temperature region; a second driving signal set (Set 12) used in the room temperature region; and a third driving signal set (Set 13) used in the high temperature region are prepared. At this time, the first to the third driving signal sets (Set 11 to Set 13), which may maintain the optimal discharge conditions in each of the temperature regions, are prepared in accordance with (or consideration of) the discharge characteristics in each of the temperature regions. For example, the first to the third driving signal sets (Set 11 to Set 13) may be set by adjusting a voltage level or a voltage waveform (an amplitude or a cycle) of the driving signal, as shown in FIG. 3.

Referring to FIG. 8, driving signals of the first to the third driving signal sets (Set 11 to Set 13) are applied to the scan electrodes (Y₁, . . . , Yₙ), the sustain electrodes (X₁, . . . , Xₙ) and the address electrodes (A₁, . . . , Aₘ), respectively, for the low temperature region, the room temperature region and the high temperature region in the regions from the beginning to a time point (H11) for driving the plasma display panel. At this time, the first to the third driving signal sets (Set 11 to Set 13) may be selected, based on the critical temperatures (T11 and T12) between the temperature regions.

Subsequently, if the operation time (H11) is passed, driving signals of the first to the third driving signal sets (Set 11 to Set 13) are applied to the scan electrodes (Y₁, . . . , Yₙ), the sustain electrodes (X₁, . . . , Xₙ) and the address electrodes (A₁, . . . , Aₘ), respectively, for the low temperature region, the room temperature region and the high temperature region in the regions from the time point (H11) to a time point (H12). At this time, the first to the third driving signal sets (Set 11 to Set 13) may be selected, based on the critical temperatures (T11′ and T12′) between the temperature regions.

At this time, the critical temperatures (T11′ and T12′) may be set to a lower or higher extent than the critical temperatures (T11 and T12), depending on the discharge characteristics of the plasma display panel, which may be achieved by changing the range of the temperature regions, and/or changing the critical temperatures between the temperature regions.

Also, if the operation time (H12) is passed, then driving signals of the first to the third driving signal sets (Set 11 to Set 13) are applied to the scan electrodes (Y₁, Yₙ), the sustain electrodes (X₁, . . . , Xₙ) and the address electrodes (A₁, . . . , Aₘ), respectively, for the low temperature region, the room temperature region and the high temperature region in the regions from the time point (H12) to a time point (H13). At this time, the first to the third driving signal sets (Set 11 to Set 13) may be selected, based on the critical temperatures (T11″ and T12″) between the temperature regions, as described above in the time (H11 to H12) regions.

At this time, the critical temperature (T11″ and T12″) may be also set to a lower or higher extent than the critical temperatures (T11′ and T12′), depending on the discharge characteristics of the plasma display panel, which may be achieved by changing the range of the temperature regions, and/or changing the critical temperatures between the temperature regions.

The optimal discharge conditions may be maintained to correspond to the changes of the discharge characteristics depending on the temperature and the use time by changing the range of the temperature regions and/or changing the critical temperatures between the temperature regions depending on the use time, as described above.

FIG. 9 is a block view illustrating a plasma display apparatus according to an embodiment of the present invention.

As shown in FIG. 9, in a plasma display panel 210, a large number of pixels 200 are defined by (or composed of) a large number of scan electrode lines (Y₁, . . . , Yₙ) and sustain electrode lines (X₁, . . . , Xₙ) which are arranged in parallel with each other; and a large number of address electrode lines (A₁, . . . , Aₘ) are arranged to cross the scan electrode lines (Y₁, . . . , Yₙ) and the sustain electrode lines (X₁, . . . , Xₙ).

The scan electrode lines (Y₁, . . . , Yₙ) are connected to a scan driver 220, the address electrode lines (A₁, . . . , Aₘ) are connected to an address driver 230, and the sustain electrode lines (X₁, . . . , Xₙ) are connected to a sustain driver 240.

Also, the plasma display panel 210 further includes an image processing unit for receiving an analog image signal from an external source and for generating a digital image signal, for example an 8-bit red (R), green (G) and blue (B) image data, a clock signal, and vertical and horizontal synchronization signals; a controller for generating a control signal in accordance with the internal image signal supplied from the image processing unit; and a drive voltage generation unit for generating a set up voltage (Vset), a scan voltage (Vscn-l and Vscn-h), a sustain voltage (Vs), a data voltage (V_{A}), etc.

For example, the driving signal sets for the temperature regions, prepared by the user, may be stored in the controller or in each of the drivers 220, 230, 240, and the temperature may be sensed by a temperature sensor, etc., installed inside or outside the plasma display panel 210, and the time may be accumulated by an internal counter, etc.

The controller receives the sensed temperature and the time, and then applies driving signals of the driving signal sets, in accordance with the sensed temperature and the time, to the sustain electrode lines (X₁, . . . , Xₙ), the scan electrode lines (Y₁, . . . , Yₙ) and the address electrode lines (A₁, . . . , Aₘ) through the driver 220, 230, 240.

In the plasma display panel, the discharge characteristics are changed, for example the firing voltage is lowered depending on the temperature and the use time, etc., in order to prevent (or protect from) the undesired discharge caused by the change of the discharge characteristics. Here, a driving signal set, which may maintain the optimal discharge conditions in each of the temperature regions, is prepared in consideration of the discharge characteristics of the plasma display panel, and the plasma display panel is driven by a driving signal of the selected driving signal set depending on the temperature and the time in an embodiment of the present invention. The undesired discharges caused by the temperature and the use time may be prevented (or blocked) at the same time by changing the range of the temperature regions and/or changing the critical temperatures between the temperature regions depending on the use time. Image quality and reliability of the display device may be improved by incessantly (or continuously or dynamically) maintaining the optimal discharge conditions to correspond to the change of the discharge characteristics according to the temperature and the use time.

The description provided herein is just exemplary embodiments for the purpose of illustrations only, and not intended to limit the scope of the invention, so it should be understood that other equivalents and modifications could be made thereto without departing from the spirit and scope of the invention as those skilled in the art would appreciate. Therefore, it should be understood that the present invention has a scope that is defined in the claims and their equivalents.

What is claimed is:

1. A method for driving a plasma display panel including pixels formed by a plurality of first electrodes, a plurality of second electrodes, and a plurality of third electrodes, the third electrodes crossing the first and second electrodes, the method comprising:
preparing a plurality of driving signal sets having different voltage waveforms to be applied to the first, second, and third electrodes; and
applying one of the plurality of the driving signal sets to the first, second, and third electrodes in accordance with a temperature and a time.

2. The method for driving a plasma display panel according to claim 1, wherein the different voltage waveforms are determined by the discharge characteristics of the plasma display panel in accordance with the temperature.

3. The method for driving a plasma display panel according to claim 1, wherein the temperature is categorized into a plurality of temperature regions and the time is categorized into a plurality of time regions, and wherein the temperature regions are changed according to the time regions.

4. The method for driving a plasma display panel according to claim 3, wherein at least two of the driving signal sets correspond to at least two of the temperature regions, respectively.

5. The method for driving a plasma display panel according to claim 3, wherein at least three of the temperature regions are categorized into a low temperature region, a room temperature region and a high temperature region.

6. The method for driving a plasma display panel according to claim 3, wherein at least two of the time regions are categorized into use times of the plasma display panel.

7. The method for driving a plasma display panel according to claim 1, wherein the temperature is categorized into a plurality of temperature regions and the time is categorized into a plurality of time regions, and wherein critical temperatures between the temperature regions are changed according to the time regions.

8. The method for driving a plasma display panel according to claim 7, wherein the driving signal sets are changed and applied to the plasma display panel when the temperature reaches each of the critical temperatures.

9. The method for driving a plasma display panel according to claim 7, wherein at least three of the temperature regions are categorized into a low temperature region, a room temperature region and a high temperature region.

10. The method for driving a plasma display panel according to claim 7, wherein at least two of the time regions are categorized into use times of the plasma display panel.

11. A method for driving a plasma display panel including pixels formed by a plurality of first electrodes, a plurality of second electrodes, and a plurality of third electrodes, the third electrodes crossing the first and second electrodes, the method comprising:
preparing a plurality of driving signal sets having different voltage waveforms to be applied to the first, second, and third electrodes;
measuring a temperature of the plasma display panel;
measuring an operating time of the plasma display panel; and
applying one of the plurality of the driving signal sets to the first, second, and third electrodes in accordance with the temperature of the plasma display panel and the operating time of the plasma display panel.

12. The method for driving a plasma display panel according to claim 11, wherein the different voltage waveforms are determined by the discharge characteristics of the plasma display panel in accordance with the temperature of the plasma display panel.

13. The method for driving a plasma display panel according to claim 11, wherein the temperature of the plasma display panel is categorized into a plurality of temperature regions and the operating time of the plasma display panel is categorized into a plurality of time regions, and wherein the temperature regions are changed according to the time regions.

14. The method for driving a plasma display panel according to claim 13, wherein the driving signal sets correspond to the temperature regions, respectively.

15. The method for driving a plasma display panel according to claim 13, wherein the temperature regions are categorized into a low temperature region, a room temperature region and a high temperature region.

16. The method for driving a plasma display panel according to claim 13, wherein the time regions are categorized into times after numbers of sustain discharges of the plasma display panel.

17. The method for driving a plasma display panel according to claim 11, wherein the temperature of the plasma display panel is categorized into a plurality of temperature regions and the operating time of the plasma display panel is categorized into a plurality of time regions, and wherein critical temperatures between the temperature regions are changed according to the time regions.

18. The method for driving a plasma display panel according to claim 17, wherein the driving signal sets are changed and applied to the plasma display panel when the operating temperature of the plasma display panel reaches each of the critical temperatures.

19. The method for driving a plasma display panel according to claim 17, wherein at least three of the temperature regions are categorized into a low temperature region, a room temperature region and a high temperature region.

20. The method for driving a plasma display panel according to claim 17, wherein the time regions are categorized into times after numbers of sustain discharges of the plasma display panel.
